(19) United States
(12) Patent Application Publication
(10) Pub. No.: US 2004/0012504 A1
(43) Pub. Date: Jan. 22, 2004

(54) Automatic control for hijacking and emergency situations

(75) Inventor: John H. Lee, Olathe, KS (US)

Correspondence Address: John H. Lee, 1441 N Lucy Montgomery Way, Olathe, KS, 66061, US

(73) Assignee: Rigel Technology Corporation, Shawnee, KS

(21) Appl. No.: 10/197,717

(22) Filed: Jul. 19, 2002

(51) Int. Cl. G08B 21/00

(52) U.S. Cl. 340/945; 340/574

(57) ABSTRACT

A method for controlling hijacking and emergency situations for airplanes and vehicles is provided. A set of switch, resistant devices and fuel valve can be used to control the airplanes or vehicles to low speed, off and on. The flight direction can be set to turn the airplanes around to avoid the hijacking target. The emergency light and alarm can be turned on to warn people before and during the controlling period of time. This method provides an economic and practical solution for controlling hijacking and emergency situations for airplanes and vehicles.

Reference Cited:
U.S. Pat. Documents

| | | | |
|---|---|---|---|
| 4928506 | May, 1990 | Radziewicz | 70/176 |
| 5486806 | Jan., 1996 | Firari et al. | 340/426 |
| 5494130 | Feb., 1996 | Foster | 180/287 |
| 5574425 | Nov., 1996 | Shu | 340/426 |
| 5805054 | Sep., 1998 | Baxter | 340/426 |
| 6158692 | Dec., 2000 | Abild et al. | 244/129.5 |
| 6373381 | Apr., 2002 | Wu | 340/426 |
| 6388412 | May, 2002 | Reed et al. | 318/466 |
| 6400042 | Jun., 2002 | Winner et al. | 307/10.5 |

### BACKGROUND OF THE INVENTION

This present invention relates to a practical and economic control for hijacking and emergency situations by controlling the flight speed and flight direction for airplanes and by controlling the driving speed for vehicles.

Prior to Sep. 11, 2001, US Federal Aviation Administration (FAA) regulations allowed knives with blades up to four inches to be carried on board airplanes. As far as we have known that the hijackers did not violate the security procedures. They did not have weapons other than box cutters and knives. How to prevent huge damages such as “September 11” from the hijackings of airplanes in the future is our big concern. We need to develop some efficient security devices and systems at reasonable costs. Many US patents, which related to the security devices and methods for airplanes and vehicles, have been issued.

U.S. Pat. No. 6,400,042 discloses an anti-theft method for motor vehicle wherein a personal identification unit is carried by an authorized operator of said motor vehicle and includes means for identifying its location in the vicinity of the motor vehicle. U.S. Pat. No. 6,388,412 discloses an operator control system for controlling the operation of an electric motor driven door or gate operator unit having a speed reducing gear drive mechanism and a brake unit for positive braking of the motor output shaft. The electrically operated brake may be controlled on a variable duty cycle to provide smooth braking action in both directions of movement of the door. U.S. Pat. No. 6,373,381 discloses a vehicle security method, which comprises a control unit having a central processor or microprocessor, a receiver connected to the microprocessor for receiving signals from a remote transmitter. U.S. Pat. No. 6,158,692 discloses an electric remote control method for a pressurized load carrying non-plug cargo door. U.S. Pat. No. 5,805,054 discloses an automobile theft prevention device including a bistable switching device that receiving a voltage input, delivers and controls a voltage output to drive an essential electrical circuit in the engine electrical system of an automobile. U.S. Pat. No. 5,574,425 discloses an anti-hijacking security method for a vehicle that provides the owner with a period of time to reach safety before beginning a series of warning alarms to the unauthorized drive. The alarm can only be deactivated by means of an access code entered through a keyboard. U.S. Pat. No. 5,494,130 discloses an anti-hijacking method to comprise a fuel cut-off valve to the vehicle engine. The controller may control the fuel cut-off valve to stop the flow to the vehicle engine, thereby stalling the engine. The delay period is preferably long enough to allow the vehicle to be driven a safe distance away from the scene of the hijacking. U.S. Pat. No. 5,486,806 discloses a method to install a fuel restricting solenoid valve in the vehicle's fuel line. The solenoid valve may be controlled from an open position to a closed position to prevent a hijacking situation. U.S. Pat. No. 4,928,506 discloses a method to have a valve for securing the fuel line or the hydraulic brake line with a manually-operated lock to prevent theft.

It is very important to provide some practical and -economic methods for preventing and controlling hijacking and theft emergency situations for airplanes and vehicles.

### DESCRIPTION OF THE INVENTION

The present invention provides a practical and economic method to control hijacking and theft emergency situations by controlling the engine speed and flight direction for airplanes and by controlling the engine speed for vehicles.

A simple set of switches and resistance devices can be installed to control the fuel pump, engine or power system. The switches can be turned to make the flight speed to low speed level, off and on by a control panel in the airplane, remote controller with short distance and automatic control system with long distance.

Another option is to install a valve into the fuel line of an airplane. The valve can be turned to low speed level, off or on by a control panel in the airplane, remote controller with short distance and by automatic control system with long distance.

For a vehicle, the engine speed can be controlled to low speed, off and on by a control switch or remote controller simply.

Besides the flight speed, the flight direction under two dimensions and three dimensions can be set to certain positions to turn the airplane around as a big circle. Then the damage by the airplane can be avoided to hit the hijacking target.

The control panel can be controlled by the crew members in the airplane. The remote controller can be controlled by the airplane pilot or vehicle driver. The automatic control system may be controlled by a central location in an airport. The signals may be transferred from the airport to the airplane through the towers. The emergency light and alarm systems can be set in the control location and airplane before and during the controlling period of time.

If an emergency hijacking situation for an airplane happens, the first option is to reduce the flight speed and to turn the flight direction around by the control panel, remote controller and automatic control system. The emergency light and alarm systems may be on in the control location and airplane. The hijacked airplane will be flown around in the air to not go to the target location and to avoid the hijacking purpose. The ground controller can let other pilots of other airplanes to not fly in the area, where the hijacked airplane flies around. The negotiations may be reached between the two parties. There should be long enough time to resolve the hijacking problem before all fuel is used. The last option is to turn the switch or valve to off to stop the energy for the airplane to avoid more damages to more people and buildings except to the hijacked airplane and the people in the airplane.

If an emergency hijacking situation for a vehicle happens, the vehicle driver can turn the engine to low speed, turn on the emergency light and alarm and turn the engine to off for the hijacked vehicle. The actions of reducing speed, emergency light, alarm and turning off the engine may be programmed to be activated or deactivated by the car or truck driver. The car or truck driver should consider the safety for himself or herself. For preventing a theft situation such as parking a vehicle in a public location, the car or truck driver can turn the switch to off position for the vehicle by a control switch or remote controller. The vehicle can be driven only after the switch or valve is activated.

### DETAIL DESCRIPTION OF THE PREFERRED EMBODIMENTS

The following examples set forth preferred methods in accordance with the invention. It is to be understood, however, that these examples are provided by way of illustration and nothing therein should be taken as a limitation upon the overall scope of the invention.

### EXAMPLE 1

A car was equipped with an off/on switch to prevent a theft situation. The switch of the car was turned off and parked on a street. The car could not be driven when the switch was turned off. After the switch was turned on, then the car could be driven.

### EXAMPLE 2

A toy airplane was controlled by a remote controller. The driving direction was set to a position about twenty degrees. The airplane was turned around as a big circle when the airplane was driven by the remote controller.

What is claimed is:

1. A method of reducing the flight speed and turning the flight direction around to control hijacking and emergency situations for an airplane.

2. The method of claim 1 wherein a set of switches and resistant devices or fuel valve are used for reducing the flight speed for the airplane.

3. The method of claim 1 wherein the flight direction under two dimensions or three dimensions is set to turn the airplane around for avoiding the hijacking target.

4. The method of claim 1 wherein an emergency light system is turned on for warning the people.

5. The method of claim 1 wherein an alarm system is turned on for warning the people.

6. The method of claim 1 wherein the airplane is controlled by a control panel in the airplane manually, remote controller for short distance and control system for long distance automatically.

7. A product is produced according to the method of claim 1.

8. A method of turning the flight speed of an airplane to low speed, off and on to control hijacking and emergency situations for the airplane.

9. The method of claim 8 wherein a set of switches and resistant devices or fuel valve are used for turning the engine to low speed, off and on for the airplane.

10. The method of claim 8 wherein an emergency light system is turned on for warning the people.

11. The method of claim 8 wherein an alarm system is turned on for warning the people.

12. The method of claim 8 wherein the airplane is controlled by a control panel in the airplane manually, remote controller for short distance and control system for long distance automatically.

13. A product is produced according to the method of claim 8.

14. A method of turning the driving speed of a vehicle to low speed, off and on to control hijacking, theft and emergency situations for the vehicle.

15. The method of claim 14 wherein a set of switches and resistant devices or fuel valve are used for turning the engine to low speed, off and on for the vehicle.

16. The method of claim 14 wherein an emergency light is turned on for warning the people.

17. The method of claim 14 wherein an alarm is turned on for warning the people.

18. The method of claim 14 wherein the vehicle is controlled by a control switch and remote controller.

19. The method of claim 14 wherein the actions of reducing speed, emergency light, alarm and turning off the engine may be programmed to be active or inactive by a control switch and remote controller.

20. A product is produced according to the method of claim 14.
